(19) United States
(12) Patent Application Publication
(10) Pub. No.: US 2025/0348803 A1
(43) Pub. Date: Nov. 13, 2025

(54) MANAGEMENT SYSTEM AND MANAGEMENT METHOD

(71) Applicant: TOYOTA JIDOSHA KABUSHIKI KAISHA, Toyota-shi (JP)

(72) Inventors: Satoshi TOYOSHIMA, Toyota-shi (JP); Shiro ODA, Anjo-shi (JP); Takeshi MATSUI, Nisshin-shi (JP)

(73) Assignee: TOYOTA JIDOSHA KABUSHIKI KAISHA, Toyota-shi (JP)

(21) Appl. No.: 19/012,926

(22) Filed: Jan. 8, 2025

(30) Foreign Application Priority Data
May 8, 2024 (JP) 2024-075723

(51) Int. Cl. G06Q 10/0631

(52) U.S. Cl. CPC G06Q 10/06311; G06Q 10/06314

(57) ABSTRACT

The management system according to the present embodiment acquires unit information on a plurality of accessory units that enable the autonomous mobile robot to execute a plurality of different services by being used in combination with the autonomous mobile robot, acquires service information on a plurality of types of services to be executed by the autonomous mobile robot, and sets an operation schedule of the autonomous mobile robot and the plurality of accessory units with reference to the unit information so as to execute a plurality of types of services based on the service information, and outputs output information indicating the operation schedule. A machine learning model such as deep learning may be used for controlling the robot and setting the schedule.

### CROSS-REFERENCE TO RELATED APPLICATION

This application claims priority to Japanese Patent Application No. 2024-075723 filed on May 8, 2024, incorporated herein by reference in its entirety.

### BACKGROUND

### 1. Technical Field

The present disclosure relates to a management system and a management method.

### 2. Description of Related Art

WO 2023/86665 discloses an autonomous mobile robot that tows a wheeled cart. The autonomous mobile robot includes a traction arm that tows the wheeled cart. The autonomous mobile robot tows the wheeled cart with the traction arm inserted under the wheeled cart.

### SUMMARY

In WO 2023/86665, the autonomous mobile robot can execute a transport service of transporting the wheeled cart. There is a desire to execute a service other than the transport service using such a mobile robot. In WO 2023/86665, however, the autonomous mobile robot can only execute the transport service.

An aspect of the present embodiment provides
a management system for an autonomous mobile robot, the management system being configured to:
acquire unit information about a plurality of accessory units that enables the autonomous mobile robot to execute a plurality of different services when used in combination with the autonomous mobile robot;
acquire service information about a plurality of types of services to be executed by the autonomous mobile robot;
set an operation schedule of the autonomous mobile robot and the accessory units with reference to the unit information such that the types of services are executed based on the service information; and
output information that indicates the operation schedule.

An aspect of the present embodiment provides
a management method for an autonomous mobile robot, the management method including:
acquiring unit information about a plurality of accessory units that enables the autonomous mobile robot to execute a plurality of different services when used in combination with the autonomous mobile robot;
acquiring service information about a plurality of types of services to be executed by the autonomous mobile robot;
setting an operation schedule of the autonomous mobile robot and the accessory units with reference to the unit information such that the types of services are executed based on the service information; and
outputting output information that indicates the operation schedule.

According to the present disclosure, it is possible to provide a management system and a management method capable of obtaining an operation schedule of an autonomous mobile robot when the autonomous mobile robot is used together with accessory units.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a management system according to the present embodiment;

FIG. 2 is a block diagram illustrating a control system of the management apparatus;

FIG. 3 is a time table showing schedules before and after coordination; and

FIG. 4 is a flowchart illustrating a management method.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

### Overall Configuration

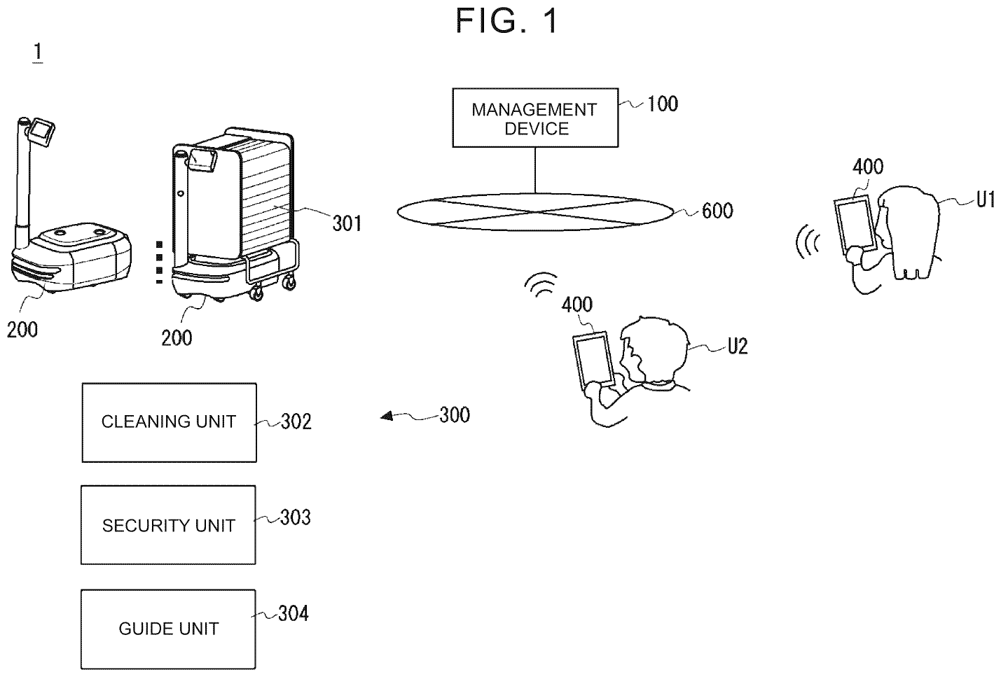

The management system according to the present embodiment is a system for managing an autonomous mobile robot capable of executing various services such as a transport service (also referred to as a transport task). FIG. 1 is a schematic diagram illustrating a configuration of a management system 1. The management system 1 includes a management device 100, a robot 200, an accessory unit 300, a network 600, and a user terminal 400. The management system 1 is a system for managing a schedule of one or a plurality of robots 200 and an accessory unit 300 thereof.

The accessory unit 300 is used in combination with the robot 200 to execute each service. For example, the accessory unit 300 is a conveyance unit 301, a cleaning unit 302, a security unit 303, and a guide unit 304. The accessory unit 300 is not limited thereto, and may include a unit for another service. The accessory unit 300 may be free of one or more of the four above. It is sufficient that the robot 200 can execute two or more different services.

The robot 200 is an autonomous mobile robot and executes a plurality of services such as transportation, cleaning, security, and guidance. The robot 200 autonomously moves medical welfare facilities such as hospitals, rehabilitation centers, nursing facilities, and residential facilities for the elderly. The robot 200 is used for transporting a medicine, a medical device, a meal, a tableware, a medical record, a fixture, a sample, a linen, a person, and the like. The transport object may be a person, such as a patient. Moreover, the system according to the present embodiment can also be used in commercial facilities such as shopping malls. The robot 200 includes wheels, a chassis, a motor, a sensor, a battery, a controller, and the like. When the management system 1 includes a plurality of robots 200, a unique identification number (ID) is assigned to each of the robots 200.

The accessory unit 300 includes a conveyance unit 301, a cleaning unit 302, a security unit 303, and a guide unit 304. The robot 200 mounts any one of the conveyance unit 301, the cleaning unit 302, the security unit 303, and the guide unit 304 in accordance with a service to be executed. For example, the robot 200 mounts the conveyance unit 301 when the transport service is executed. The robot 200 is equipped with a cleaning unit 302, a security unit 303, or a guide unit 304 when executing a cleaning service, a security service, or a guidance service, respectively. As described above, the accessory unit 300 is prepared in advance for each service to be executed.

The robot 200 selectively attaches any one of the conveyance unit 301, the cleaning unit 302, the security unit 303, and the guide unit 304. The robot 200 selectively uses the accessory unit 300 according to the service to be executed. The robot 200 may be capable of mounting two or more accessory units 300 at the same time. In addition, the robot 200 may be configured to be able to mount the accessory unit 300 only by its own operation, but may be configured to be assisted by a user or the like.

The conveyance unit 301 is an accessory unit 300 for transporting a conveyed object. For example, the conveyance unit 301 is a wagon or a cart with wheels, in which a conveyed object can be mounted. The bogie portion of the robot 200 serves as a stage on which a wagon or the like is mounted. The robot 200 has an elevating function for lifting the conveyance unit 301. When the carriage portion of the robot 200 enters the lower side of the conveyance unit 301, an elevating stage or the like lifts the conveyance unit 301. Thus, the robot 200 mounts the conveyance unit 301. The robot 200 can convey the conveyed object stored in the conveyance unit 301 to the destination. The robot 200 can execute the conveyance service by mounting the conveyance unit 301. The conveyance unit 301 is used for serving a table in a restaurant, a medical welfare facility, or the like, and for a lower table. The transport unit may be used for transporting parts in a factory, transporting samples in a hospital, transporting linen in a hotel, and the like. The conveyance unit 301 may be a transfer robot including a wagon that can run together with the robot 200 and can store an article.

The cleaning unit 302 is an accessory unit 300 for cleaning a facility. The cleaning unit 302 includes a cleaner that sucks dust and the like. Alternatively, the cleaning unit 302 includes a brush, a pad for wiping a floor, a mop, and the like. When the robot 200 moves with the cleaning unit 302 mounted thereon, the floor surface is cleaned. That is, in the region where the robot 200 has moved, the floor surface is cleaned. The robot 200 can execute the cleaning service by mounting the cleaning unit 302. The cleaning unit 302 may also be a remotely controllable robotic cleaner. In this case, the robot 200 performs the cleaning service by remotely controlling the cleaning unit 302 by wireless communication. The cleaning unit 302 may be a cleaning robot that is mechanically connectable to the robot 200. Alternatively, the cleaning unit 302 may be a cleaning robot that can run with the robot 200.

The security unit 303 is an accessory unit 300 for securing a facility. The security unit 303 includes, for example, various sensors for detecting an intruder or an abnormality. For example, the security unit 303 includes a camera, an infrared camera, a ranging sensor, an optical sensor, a thermal sensor, and a smoke sensor as sensors. A lighting device for illuminating an intruder or an abnormal portion may be provided. The accessory unit 300 may have an alarm function or the like for notifying when an abnormality is detected. The robot 200 can execute the security service by wearing the security unit 303. The robot 200 tours the facility with the security unit 303 attached. The security unit 303 may be a security robot that is mechanically connectable to the robot 200. The security unit 303 may be a security robot that can run with the robot 200.

Guide unit 304 is an accessory unit 300 for guiding a facility. For example, the guide unit 304 guides the visitor of the facility a route to the destination or the like. The guide unit 304 has an input device for a visitor to input a destination. The input device includes a touch panel and buttons. The input device also includes a microphone for voice input. The robot 200 moves to a destination to guide the visitor. The guide unit 304 may include a display device for displaying a route and a speaker for outputting a voice of the route.

As described above, the various accessory units 300 are used in combination with the robot 200, so that the robot 200 can execute a plurality of different services. That is, the robot 200 executes a service corresponding to the accessory unit 300 mounted thereon.

A plurality of accessory units 300 for one service may be provided. Further, the accessory units 300 that perform the same service may be divided into a plurality of types. In the management system 1, for example, two or more conveyance units 301 may be provided. In this case, the two robots 200 can simultaneously execute the conveyance service using the conveyance unit 301. Further, a plurality of types of accessory units 300 may be prepared for one service. For example, the shape and size of the conveyance unit 301 may be different depending on the contents of the conveyed material.

In addition, a plurality of types of robots 200 may be operated in the facility. The executable services may be different depending on the type of the robot 200 or the like. For example, the accessory unit may be different depending on the type of the robot 200. In addition, at least a part of the robot 200 may be capable of executing a service without using an accessory unit. For example, the robot 200 may be a transfer robot that performs a transfer service by itself. Alternatively, the robot 200 may be a cleaning robot that performs a cleaning service by itself. The robot 200 may be a security robot that performs security services by itself. Alternatively, the robot 200 may be a guidance robot that performs guidance service by itself. At least some of the robots may be dedicated robots that provide a single service, such as transport services, cleaning services, security services, guidance services, and the like.

As described above, when the accessory unit 300 is used in combination with the robot 200, a plurality of different services can be executed by the robot 200. That is, the robot 200 executes a service corresponding to the accessory unit 300 mounted thereon. A unique identification number (ID) is assigned to the accessory unit 300.

The user U1 or the user U2 can use the user terminal 400 to make a service request such as a conveyance request for a conveyed object. For example, the user terminal 400 is a tablet computer, smart phone, or the like. The user terminal 400 only needs to be an information processing device capable of wireless or wired communication.

In the present embodiment, the robot 200 and the user terminal 400 are connected to the management device 100 via the network 600. The network 600 is a wired or wireless local area network (LAN) or wide area network (WAN). Further, the management device 100 is connected to the network 600 by wire or wirelessly. For example, the communication between the devices may be based on a general-purpose communication standard such as Wi-Fi.

Various types of signals transmitted from the user terminal 400 of the user U1, U2 are once transmitted to the management device 100 via the network 600 and transferred from the management device 100 to the target robot 200. Similarly, various signals transmitted from the robot 200 are once transmitted to the management device 100 via the network 600 and transferred from the management device 100 to the target user terminal 400. The management device 100 is a server connected to each device, and collects data from each device. The management device 100 is not limited to a physically single apparatus, and may include a plurality of apparatuses that perform distributed processing. In addition, the management device 100 may be distributed and arranged in an edge device such as the robot 200. For example, a part or all of the management system 1 may be mounted on the robot 200.

The user terminal 400 and the robot 200 may transmit and receive signals without using the management device 100. For example, the user terminal 400 and the robot 200 may transmit and receive signals directly by wireless communication. The management device 100 may collect data from a monitoring camera or a communication device (not shown).

It is assumed that a plurality of types of robots 200 are used in a facility. The management device 100 assigns a service to each robot 200. Each of the robots 200 is equipped with an accessory unit 300 corresponding to the assigned service, and executes the service. The service executed by the robot 200 may be entered by a user U1 or a user U2, or may be scheduled in advance. For example, a user U1 or the like operates the user terminal 400 to make a service request. A user U1 or the like can enter the type of service to be executed. A user U1 or the like may enter an area, a time-zone, or the like in which the service is executed. The management device 100 creates an operation schedule for the robot 200 to efficiently execute the service. The management device 100 outputs the created schedule to the user terminal 400, the robot 200, or the like.

In such an overall configuration, each element of the management system 1 can be distributed among the robot 200, the user terminal 400, and the management device 100 to construct the management system 1 as a whole. Further, it is possible to collect substantial elements for achieving the transportation of the transported object in a single device to construct the system.

### Control System

The management device 100 includes a server computer and the like, and performs an operation for controlling and managing the robot 200, the accessory unit 300, and the like. The management device 100 can be implemented as, for example, a program-executable device such as a central processing unit (CPU: Central Processing Unit) of a computer. The functions described later can also be realized by a program. The management device 100 manages each unit ID of the accessory unit 300 and the robot ID of the robot 200.

For example, the management device 100 manages a schedule of one or a plurality of robots 200 so that the robot 200 can efficiently execute a service. For example, when receiving a service request from the user terminal 400 or the like, the management device 100 selects one robot 200 from the plurality of robots 200 and instructs the robot 200 to execute the service. Alternatively, the management device 100 instructs the robot 200 to use the accessory unit 300.

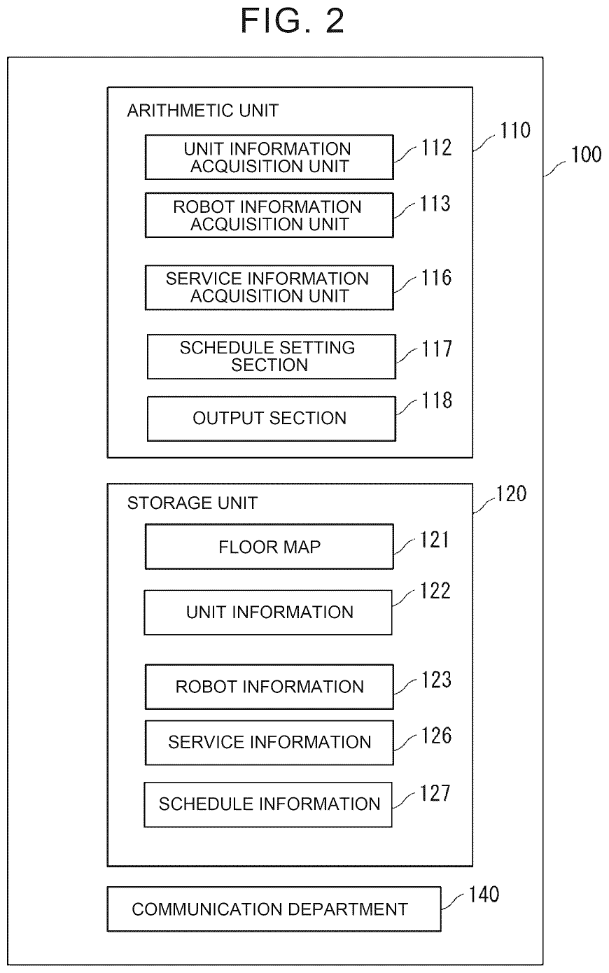

FIG. 2 is a block diagram illustrating a control system of the management device 100 according to the present embodiment. As illustrated in FIG. 2, the management device 100 includes an arithmetic processing unit 110, a storage unit 120, and a communication unit 140. The arithmetic processing unit 110 includes a unit information acquisition unit 112, a robot information acquisition unit 113, a service information acquisition unit 116, a schedule setting unit 117, and an output unit 118.

The arithmetic processing unit 110 may perform arithmetic processing other than these. For example, the arithmetic processing unit 110 may perform route planning or the like according to the schedule of each robot. In this case, the management device 100 transmits a movement path to each robot. Of course, the robot 200 may perform route planning. In this case, when the management device 100 transmits a route, a destination, or the like to the robot 200, the robot 200 performs route planning.

The storage unit 120 stores a floor map 121, unit information 122, robot information 123, service information 126, and schedule information 127. FIG. 2 shows a part of the information stored in the storage unit 120, and information other than the information shown in FIG. 2 may be stored in the storage unit 120. For example, the storage unit 120 may store programs, control parameters, and the like.

The floor map 121 is map information of a facility. The floor map 121 may include information about a place where the service is executed. For example, the floor map 121 may be created in advance. In addition, the floor map 121 may be not map information of the entire facility but map information partially including an area in which a service is to be executed. Each robot autonomously travels to the destination by referring to the floor map.

The unit information 122 includes information related to the accessory unit 300 operating in the facility. The unit information 122 includes information on the type, model number, servicing content, ID, usage starting time, usage ending time, usage time period, usage area, and the like of the accessory unit 300. Further, the unit information 122 may include information indicating the order of use, whether it has been used, or other information regarding the accessory unit 300. The unit information 122 may include position information indicating a current position, a storage location, and the like of the accessory unit 300. The unit information 122 may include information indicating the type of robot to which the accessory unit 300 can be attached.

The storage unit 120 stores the unit information 122 as a data base in which various kinds of information are stored for each unit ID. In addition, the unit information 122 may have constraints such as a continuous operation time and a preparable amount. The continuous operation time may be set by the battery capacity of the accessory unit 300 or the like. The preparable amount may be set based on the loading amount of the conveyed object or the like. The unit information 122 is information recorded in advance. The unit information 122 may be updated by addition, maintenance, discarding, or the like of the accessory unit 300. The unit information 122 may include information about the battery capacity of the accessory unit 300.

The robot information 123 includes information related to the robot 200 operating in the facility. The robot information 123 includes information on the type, model number, executable service, transportable conveyance object type, accessory unit 300, and the like of the robot 200. The storage unit 120 stores the robot information 123 as a data base in which various kinds of information and the like are stored for each robot ID. The robot information 123 may include a current position of the robot, a moving route, information indicating whether the service is being executed or suspended, and information regarding the service being executed. The robot information 123 may include information about an accessory unit in use or a conveyed object being conveyed.

The robot information 123 may have constraints such as a continuous operation time and a preparable amount. The continuous operation time may be set by the battery capacity of the robot 200 or the like. The preparable amount may be set based on the loading amount of the conveyed object or the like. The robot information 123 is information recorded in advance. The robot information 123 may be updated by addition, maintenance, discarding, or the like of the robot 200. The robot information 123 may include information about the battery capacity of the accessory unit 300.

The service information 126 includes information about a service executed by the robot 200. The service information 126 includes information on a type of service, a start time, an end time, a time zone to be executed, an area to be executed, and the like. For example, the service information 126 may be input information input by the user U1 at the user terminal 400. The service information 126 may include information indicating an execution order, whether the execution has been completed, or information regarding the accessory unit 300. Further, the service information 126 may include information indicating a charging time period of the robot 200 or the accessory unit 300. For example, the service information 126 includes information indicating a free time zone or a use time zone for each charger.

The schedule information 127 includes information indicating schedules of the plurality of robots 200. For example, the schedule information 127 includes information related to services executed by the respective robots 200. The schedule information 127 includes information on the type of service, the scheduled start time, and the scheduled end time. The schedule information 127 may include information about an area or a point where the service is to be performed. For example, the schedule information 127 may include information regarding a receiving location of a conveyed object or a location of a conveyance destination. The storage unit 120 stores the above-described information for each robot as the schedule information 127 as a database. Schedule information 127 may include information regarding the accessory unit 300 used by the robot 200. For example, the schedule-information 127 may include a robot ID or a unit ID for each service.

The unit information acquisition unit 112 acquires the unit information 122. The unit information acquisition unit 112 acquires information such as the type of service of the accessory unit 300 for each accessory unit 300. The unit information acquisition unit 112 acquires the unit information 122 in association with the unit ID. The unit information acquisition unit 112 reads the unit information 122 from the storage unit 120. Alternatively, the unit information acquisition unit 112 may acquire the unit information 122 from the detection data detected by a sensor such as a camera.

The robot information acquisition unit 113 acquires the robot information 123. The robot information acquisition unit 113 acquires information such as an executable service of the robot for each robot. The robot information acquisition unit 113 acquires the robot information 123 in association with the robot ID. Further, the robot information acquisition unit 113 or the unit information acquisition unit 112 may acquire information on a combination with an accessory unit that can be attached to each robot. For example, the storage unit 120 may store a combination of the robot ID and the unit ID.

The service information acquisition unit 116 acquires the service information 126. The user U1 inputs input information related to the service request at the user terminal 400 or the like. When the management device 100 receives the input information, the service information acquisition unit 116 acquires information on the type, the start time, the end time, the time period to be executed, the region to be executed, and the like of the service. The service information acquisition unit 116 writes the acquired service information 126 into the storage unit 120. As described above, the service information 126 of the storage unit 120 is updated as needed in accordance with the input information of the user.

The schedule setting unit 117 sets a schedule based on the service information 126 and the unit information 122. Based on the service information, the schedule setting unit 117 refers to the unit information so as to execute a plurality of types of services, and sets an operation schedule of the robot 200 and the plurality of accessory units 300. The schedule setting unit 117 writes the schedule information 127 into the storage unit 120. The schedule information 127 indicates an operation schedule of each of the robot 200 and the accessory unit 300. The schedule information 127 is information indicating a time zone of a service executed by each robot 200 and an accessory unit 300 used by the service.

Upon receiving the service information 126 from the user terminal 400, the schedule setting unit 117 selects the accessory unit 300 capable of executing the service indicated by the service information 126. The schedule setting unit 117 selects the robot 200 that can execute the service in the accessory unit 300. The schedule setting unit 117 determines a schedule of each service based on the service information 126 that is input information. That is, the schedule setting unit 117 sets the schedule with reference to the unit information 122 so as to execute the service indicated by the service information 126.

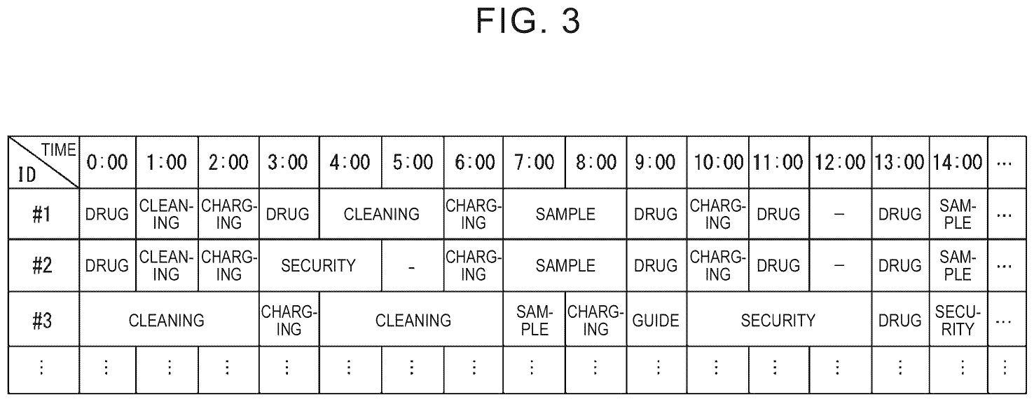

FIG. 3 is a time table illustrating an example of a schedule indicated by the schedule information 127. FIG. 3 shows an operation schedule of three robots. Hereinafter, ID of the three robots will be described as #1-#3.

The robot of #1 can execute cleaning service and conveyance service. The #1 robot is capable of carrying specimens and chemicals in the transport service. The robot with #1 cannot perform security service. The #2 robot can perform cleaning services, security services, and conveyance services. The #2 robot is capable of transporting specimens and chemicals in the transport service. The robot of #3 can perform cleaning services, guidance services, security services and conveyance services. The #3 robot is capable of transporting specimens, chemicals, and patients (people) in the transportation service. As described above, the types of services that can be executed differ depending on the robot 200. Although only the schedule of the robot 200 is shown in FIG. 3, the schedule setting unit 117 may set the schedule of each accessory unit 300.

In FIG. 3, charging indicates that each robot is charging a battery. During charging, the robot is stopping at the charging station, so the service is not running. The schedule setting unit 117 assigns a time period during which the service is suspended to the charging time. The schedule setting unit 117 sets a schedule so as to cause the plurality of robots 200 to share and execute a plurality of types of services. For example, the combination of the robot 200 and the accessory unit 300 is obtained so that the robot 200 of #1 and #2 executes the transfer service and the robot of #3 executes the security service, as in the time period from 10 o'clock to 11 o'clock in FIG. 3. Then, the schedule is calculated so that the plurality of robots 200 execute the service in combination with the respective accessory units 300. As a result, the schedule setting unit 117 can share a plurality of types of services, so that the service can be executed efficiently.

When there are two or more robots 200 capable of executing the service indicated by the service information 126, the schedule setting unit 117 sets a schedule so that the service can be executed more efficiently. The schedule setting unit 117 refers to the robot information 123 and the service information 126, and selects the robot 200 and the accessory unit 300 that are not executing other services during the service execution time. Further, the schedule setting unit 117 selects the accessory unit 300 and the robot 200 which are in the vicinity of the service execution place at the scheduled service start time. Then, the schedule setting unit 117 allocates a service to the selected accessory unit 300 and the robot 200. In addition, the schedule setting unit 117 sets the schedule so that the robot having the free time performs charging at the free time. Since the operation time of the robot can be increased efficiently, the service can be executed efficiently.

Furthermore, in the transportation service, the schedule setting unit 117 selects the robot 200 in the vicinity of the receiving location of the conveyed object at the transportation start time. Further, when the type of the conveyed object is indicated in the service information, the schedule setting unit 117 selects the robot 200 and the accessory unit 300 that can convey the conveyed object. Then, the schedule setting unit 117 sets a schedule so that the conveyance is completed by the target end time. In the case of the transportation service, the schedule setting unit 117 may select the robot 200 and the accessory unit 300 based on information such as the moving speed of the robot 200, the type of transported object that can be loaded, the loading amount, and the like.

For example, a carrier that transports a package or the like to be transported can increase the efficiency of the transportation schedule. In addition, it is possible to shorten the time required for a person to be transported to receive an appropriate treatment at a facility. At the expected arrival location, the robot can quickly load and transport the transported object. Therefore, the conveyed object can be efficiently conveyed. Further, even in a time zone where the number of employees is small, such as at midnight or on holidays, the conveyed object can be appropriately and efficiently conveyed.

In the service information, the scheduled start time and the scheduled end time of the service may not be set. For example, the service information may be a value indicating the number of times the service is executed in one day. For example, it may be information indicating that the cleaning service is performed one or more times per day. In this case, the schedule setting unit 117 can appropriately change the execution time of the service. Therefore, the schedule setting unit 117 can update the schedule so that the service is executed in a time period in which the robot 200 and the accessory unit 300 are free.

The output unit 118 generates and outputs output information indicating a schedule. For example, the output information is output as a signal used in the user terminal 400 to confirm the schedule. The output unit 118 generates a signal for displaying schedule information on a monitor or the like. Alternatively, when the user terminal 400 receives the output information, a display signal may be generated based on the output signal. The device displaying the schedule may be other than the user terminal 400 and the management device 100. For example, the schedule may be displayed on a monitor mounted on the robot 200. Alternatively, a schedule may be displayed on a monitor, a management server, or a management device installed in a facility.

The output unit 118 generates a control signal for at least one of the robot 200 and the accessory unit 300 based on the output information. The output information may include a control signal for moving to the execution place of the service, and a control signal for moving in the service. The output information may include a control signal for the robot 200 to perform a mounting operation of mounting the accessory unit 300. The robot 200 or the accessory unit 300 executes a service according to a schedule based on a control signal or the like included in the output information.

The output information may include time information such as a conveyance start time, a scheduled arrival time, a scheduled end time, and a scheduled start time. Further, the output information may include position information indicating a receiving place of the conveyed object, a destination, a mounting position of the accessory unit 300, a service execution place, and the like. Based on the output information, the robot 200 or the accessory unit 300 may generate a control signal. As a result, the robot 200 can execute the service according to the schedule.

The communication unit 140 includes a communication interface for communicating with the user terminal 400 or the robot 200. The communication unit 140 transmits a control signal and schedule information 127 for controlling the robot to the robot. The communication unit 140 may transmit information such as a destination and a moving route to the robot. The communication unit 140 receives a service request or the like from the user terminal 400.

The at least one autonomous mobile robot may include a main robot and an accessory unit. The subject robot operates autonomously as a subject. The accessory unit is used in combination with the main robot to enable the main robot to carry a predetermined type of conveyed object. As a result, the robot can convey various conveyed objects, and thus convenience can be improved.

In addition, the management device 100 may receive constraint information regarding the execution amount for each service task. The service information 126, the robot information 123, and the unit information 122 may include, for example, information such as a monthly usage fee and an upper limit execution amount. For example, when the upper limit execution amount is set in the robot 200 or the accessory unit 300, the schedule setting unit 117 performs scheduling so as not to exceed the upper limit execution amount.

The services performed by the robot 200 and the like preferably include two or more of conveyance services, security services, cleaning services, and guidance services. The robot 200 preferably executes the transportation service and at least one of the security service, the cleaning service, and the guidance service. The accessory unit 300 may be mechanically connected to the robot 200, or may be a robot that moves following the robot 200. For example, the accessory unit 300 captures an image with a camera or the like, and travels following the camera image. Alternatively, the accessory unit 300 may be a robot that is remotely controlled by a wireless signal from the robot 200.

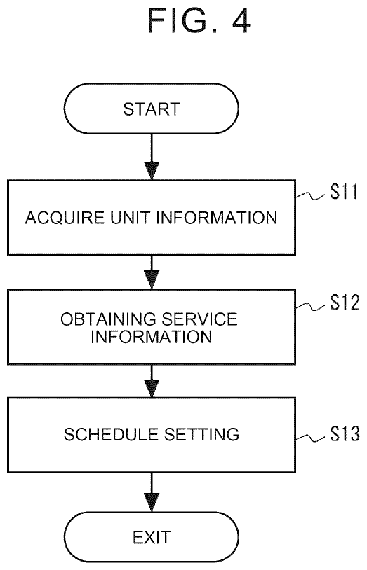

FIG. 4 is a flowchart illustrating a management method. The unit information acquisition unit 112 acquires unit information (S11). The service information acquisition unit 116 acquires service information (S12). The schedule setting unit 117 sets a schedule based on the unit information and the service information (S13). For example, the schedule setting unit 117 selects an accessory unit 300 and a robot 200 of a type capable of executing a service of service information. Then, the schedule setting unit 117 assigns the robot 200 and the accessory unit 300 to the service occupied by the service information. By doing so, it is possible to efficiently execute the transport service.

The management device 100 and the robot 200 may use a machine learning model such as deep learning in route planning and drive control. Further, in detection of a surrounding object or the like, a machine learning model such as deep learning such as RNN (Recurrent Neural Network) or CNN (Convolutional neural network) may be used.

In addition, some or all of the processing in the robot 200, the management device 100, and the like described above can be realized as a computer program. The program as described above is stored using various types of non-transitory computer-readable media, and can be supplied to a computer. The non-transitory computer-readable media include various types of tangible recording media. Exemplary non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, and solid-state memories. Semiconductor memories are, for example, mask ROM, PROM (Programmable ROM), EPROM (Erasable PROM), flash ROM, RAM (Random Access Memory). Further, the program may also be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

What is claimed is:

1. A management system for an autonomous mobile robot, the management system being configured to:
acquire unit information about a plurality of accessory units that enables the autonomous mobile robot to execute a plurality of different services when used in combination with the autonomous mobile robot;
acquire service information about a plurality of types of services to be executed by the autonomous mobile robot;
set an operation schedule of the autonomous mobile robot and the accessory units with reference to the unit information such that the types of services are executed based on the service information; and
output output information that indicates the operation schedule.

2. The management system according to claim 1, wherein the output information is output as a signal that is used to check the operation schedule on a user terminal.

3. The management system according to claim 1, wherein the management system generates a control signal for at least one of the autonomous mobile robot and the accessory units based on the output information.

4. The management system according to claim 1, wherein:
the management system manages a plurality of autonomous mobile robots; and
the management system sets the operation schedule so as to cause the autonomous mobile robots to execute the types of services in a distributed manner.

5. A management method for an autonomous mobile robot, the management method comprising:
acquiring unit information that is information about a plurality of accessory units that enables the autonomous mobile robot to execute a plurality of different services when used in combination with the autonomous mobile robot;
acquiring service information about a plurality of types of services to be executed by the autonomous mobile robot;
setting an operation schedule of the autonomous mobile robot and the accessory units with reference to the unit information such that the types of services are executed based on the service information; and
outputting output information that indicates the operation schedule.
